(19) United States
(12) Patent Application Publication
(10) Pub. No.: US 2017/0068902 A1
(43) Pub. Date: Mar. 9, 2017

(54) Modeling of Geospatial Location Over Time

(71) Applicant: Skytree, Inc., San Jose, CA (US)

(72) Inventors: Sergey Kirshner, Palo Alto, CA (US); Alexander Gray, Santa Clara, CA (US); Lawrence Kite, Los Gatos, CA (US)

(21) Appl. No.: 15/254,958

(22) Filed: Sep. 1, 2016

Related U.S. Application Data
(60) Provisional application No. 62/213,935, filed on Sep. 3, 2015.

(51) Int. Cl. G06N 7/00; G06F 17/30; G06F 17/50

(52) U.S. Cl. CPC G06N 7/005; G06F 17/5009; G06F 17/30241

(57) ABSTRACT

A system and method for predicting a user of interest's location including collecting geospatial data of a plurality of users, the plurality of users including a user of interest and other users; and generating a model for the user of interest's location based on the collected geospatial data using one or more weights associated with one or more criteria to account for data surrogacy.

### CROSS REFERENCE TO RELATED APPLICATIONS

The present application claims priority, under 35 U.S.C. §119, of U.S. Provisional Patent Application No. 62/213,935, filed Sep. 3, 2015 and entitled “Modeling of Geospatial Location Over Time,” which is incorporated by reference in its entirety.

### BACKGROUND

1. Field of the Invention

The present disclosure relates to modeling of a user's geospatial location. More particularly, the present disclosure relates to systems and methods for generating or creating a model for a user's geospatial location using weights for data surrogacy.

2. Description of Related Art

Present methods and systems may generate a baseline model using geospatial data of all users and combine the baseline model with an individual-specific model. However, the present methods and systems fail to account for any similarities or dissimilarities that may exist between the particular user of interest and the other users (i.e. the users whose data is used to generate the baseline model) as well as similarities and dissimilarities for different times such as times of day and week.

Present methods and systems may assume that location data loses some predictive value over time and, therefore, use time decay to emphasize more recent data and de-emphasize less recent data when generating a model of a user's geospatial location. However, the present methods and systems fail to account for other time-based factors that, if taken into account, may result in a more accurate model.

Thus, there is a need for a system and method that generates or creates a model that can more accurately predict a user of interest's geospatial location by overcoming one or more of the above identified issues of present methods and systems.

### SUMMARY

In general, an innovative aspect of the subject matter described in this disclosure may be embodied in methods that include collecting geospatial data for a plurality of users including the user of interest and other users, generating a geospatial model based on the geospatial data of the user of interest and based on the geospatial data of the one or more other users, wherein the geospatial model is generated using a weight to account for one or more types of data surrogacy.

According to another innovative aspect of the subject matter described in this disclosure, a system comprising one or more processors; and a memory storing instructions that, when executed by the one or more processors, cause the system to collect geospatial data of a plurality of users, the plurality of users including a user of interest and other users; and generate a model for the user of interest's location based on the collected geospatial data using one or more weights associated with one or more criteria to account for data surrogacy.

Other implementations of one or more aspects include corresponding methods, systems, apparatus, and computer program products for these and other innovative features. These and other implementations may each optionally include one or more of the following features.

For instance, the operations further include receiving information associated with an observed location, (x,y), wherein the information includes one of a probability density score associated with the observed location and the log of the probability density score associated with the observed location; receiving a quantile threshold, c; determining a density value, p_{c}, corresponding to the received quantile threshold; determining that the observed location is an outlier when p((X=x, Y=y)|t)<p_{c}; and initiating an action based on determining the observed location is an outlier.

For instance, the one or more criteria includes a time characteristic and the data surrogacy includes time surrogacy. For instance, the weights emphasize geospatial data associated with a first time characteristic in generating the model and/or de-emphasize the geospatial data associated with a second time characteristic in generating the model, the model used to predict the user of interest's location at a time consistent with the first time characteristic.

For instance, the one or more criteria includes a user characteristic and the data surrogacy includes user surrogacy. For instance, the weights emphasize geospatial data associated with one or more other users similar to the user of interest in generating the model and/or de-emphasize the geospatial data associated with one or more other users dissimilar to the user of interest in generating the model.

For instance, the one or more criteria includes a user characteristic and a time characteristic and the data surrogacy includes user surrogacy and time surrogacy.

For instance, the operations further include predicting, using the model for the user of interest's location, a current location of the user of interest; and initiating an action based on the predicted, current location of the user. For instance, the action includes one or more of requesting, generating and providing a location based recommendation. For instance, the action includes one or more of requesting, generating and providing a location based search result.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for generating a model for a user's geospatial location using weights for data surrogacy according to one implementation.

FIG. 2 is a block diagram of an example modeling server according to one implementation.

FIG. 3 depicts an example illustration of geospatial data for a plurality of users collected and used according to the techniques described herein to generate a geospatial model for a user using weights for data surrogacy according to one implementation.

FIG. 4 depicts an example illustration of probability densities associated with the generated geospatial model for a user using weights for data surrogacy according to one implementation.

FIG. 5 depicts an example illustration of probability densities associated with the generated geospatial model for a user using weights for data surrogacy superimposed on the geospatial data of the plurality of users according to one implementation.

FIG. 6 is a flowchart of an example method for creating a geospatial model using weights for data surrogacy according to one implementation.

### DETAILED DESCRIPTION

A system and method for generating a model for a user's geospatial location using weights for data surrogacy are described. The present disclosure overcomes the deficiencies of the prior art by providing a system and method for a model for a user of interest's geospatial location using weights for data surrogacy. Depending on the implementation, data surrogacy may have different types. Examples of different types of surrogacy include, but are not limited to, one or more of time characteristic surrogacy and user surrogacy.

Time characteristic surrogacy, occasionally referred to herein as “time surrogacy,” refers to using geospatial location data for one time characteristic to model a geospatial location for another time characteristic. Examples of time characteristics include, but are not limited to one or more of recentness, time of day, part of day (e.g. morning, afternoon, evening, night), day of week, part of week (e.g. weekend, weekday), day of month, part of month (1st Thursday of the month), holiday status, season, part of year, lunar phase, high or low tide, etc. In one implementation, the disclosure herein accounts for how predictive such time characteristic surrogacy may be. For example, assume that geospatial location data is available for Wednesday and a location of the user of interest is to be modeled for Friday. Wednesday's geolocation data may be highly predictive of the user of interest's location during the day (e.g. when the user works at an Office M-F). However, Wednesday's geolocation data may be less predictive for user of interest's location during Friday evening (e.g. when the user typically stays home on weeknights and goes out with friends or family Friday evenings).

User surrogacy refers to using geospatial location data of other users (i.e. geospatial location data not of the user of interest) to model a geospatial location of the user of interest. In one implementation, the disclosure herein accounts for how predictive such user surrogacy may be. For example, in one implementation, the data of other users is discounted. In one implementation, such a determination is made on a user-by-user basis for the other users. For example, assume geospatial data of the user of interest's co-worker is available, the co-worker's geospatial location data may be highly predictive of the user of interest's location during work hours; in one implementation, the surrogate data of that coworker is weighted differently than surrogate data belonging to some other user.

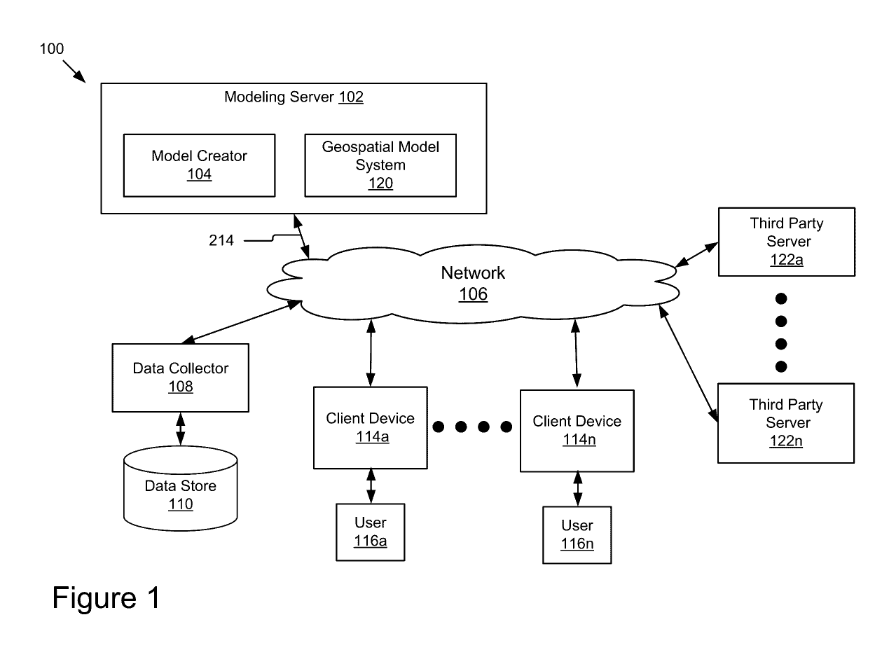

FIG. 1 shows an implementation of a system 100 for producing a geospatial model. In the depicted implementation, the system 100 includes a modeling server 102, a network 106, a data collector 108 and associated data store 110, client devices 114a . . . 114n (also referred to herein independently or collectively as 114), and third party servers 122a . . . 122n (also referred to herein independently or collectively as 122).

The modeling server 102 is coupled to the network 106 for communication with the other components of the system 100, such as the services/servers including the data collector 108, and the third party servers 122. The modeling server 102 processes the information received from the plurality of resources and devices 108, 122, and 114, or a subset thereof, to create predictive models of a user of interest's geospatial location. The modeling server 102 includes a model creator 104 for creating predictive models of a user of interest's geospatial location and a geospatial model system 120 for using the predictive models of a user of interest's geospatial location.

The servers 102, 108 and 122 may each include one or more computing devices having data processing, storing, and communication capabilities. For example, the servers 102, 108 and 122 may each include one or more hardware servers, server arrays, storage devices and/or systems, etc. In some implementations, the servers 102, 108 and 122 may each include one or more virtual servers, which operate in a host server environment and access the physical hardware of the host server including, for example, a processor, memory, storage, network interfaces, etc., via an abstraction layer (e.g., a virtual machine manager). In some implementations, one or more of the servers 102, 108 and 122 may include a web server (not shown) for processing content requests, such as an HTTP server, a REST (representational state transfer) service, or other server type, having structure and/or functionality for satisfying content requests and receiving content from one or more computing devices that are coupled to the network 106 (e.g., the modeling server 102, the data collector 108, the client device 114, etc.).

The third party servers 122 may be associated with one or more entities that receive geospatial location data. Examples of such entities include, but are not limited to, emergency service providers such as 911 call centers, cellular service providers (e.g. AT&T, Verizon, Sprint, T-Mobile), search providers (e.g. Google, Yahoo, Bing, etc.), providers of turn-by-turn navigation (e.g. Google Maps, Waze, MapQuest, Apple Maps, etc.), advertisers, mobile or tablet application developers that utilize location services provided by the mobile or tablet device, etc. It should be recognized that the preceding are merely examples of entities which may receive geospatial data and that others are within the scope of this disclosure.

The data collector 108 is a server/service which collects geospatial data from other servers, such as the third party servers 122, and/or by receiving geospatial data from the client devices 114 themselves. The data collector 108 may be a first-party server (i.e. the server is associated with the same company or service provider as the modeling server 102) or third-party server (i.e., a server associated with a separate company or service provider), which mines data, crawls the Internet, and/or obtains data from other servers. For example, the data collector 108 may collect geospatial data from other servers and then provide it as a service.

The data store 110 is coupled to the data collector 108 and comprises a non-volatile memory device or similar permanent storage device and media and, in some implementations, is accessible by the modeling server 102.

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another implementation, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, WAP, email, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the modeling server 102 and/or other components (e.g., 108 or 122) of the system 100 may aggregate data from and generate geospatial location models for a multiplicity of users 116a . . . 116n on a multiplicity of client devices 114a . . . 114n. In some implementations, a single user 116 may use more than one client device 114, which the modeling server 102 (and/or other components of the system 100) may track. For example, the third party server 122 may track the geospatial data of a user across multiple client devices 114.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different implementations of the system 100 that include one or more servers 102, 108 and 122, the network 106, and one or more client devices 114. In a first example, the one or more servers 102, 108 and 122 may each be dedicated devices or machines coupled for communication with each other by the network 106. In a second example, any one or more of the servers 102, 108 and 122 may each be dedicated devices or machines coupled for communication with each other by the network 106 or may be combined as one or more devices configured for communication with each other via the network 106. For example, the modeling server 102 and a third party server 122 may be included in the same server. In a third example, any one or more of one or more servers 102, 108 and 122 may be operable on a cluster of computing cores in the cloud and configured for communication with each other. In a fourth example, any one or more of one or more servers 102, 108 and 122 may be virtual machines operating on computing resources distributed over the internet.

While the system 100 shows only one device for each of 102, 108, 122a, 122n, it should be understood that there could be any number of devices. Moreover, it should be understood that some or all of the elements of the system 100 could be distributed and operate in the cloud using the same or different processors or cores, or multiple cores allocated for use on a dynamic as needed basis.

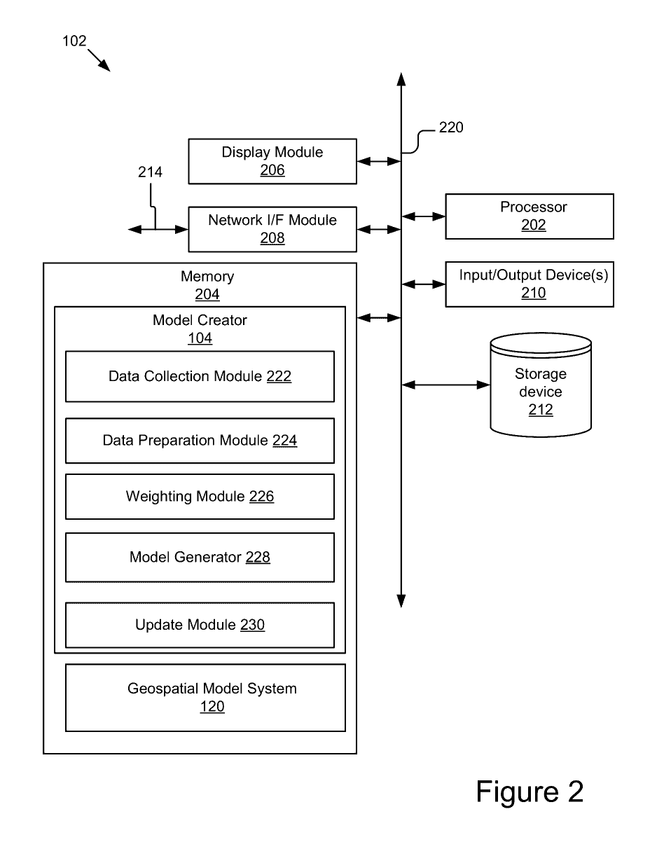

Referring now to FIG. 2, an implementation of a modeling server 102 is described in more detail. The modeling server 102 comprises a processor 202, a memory 204, a display module 206, a network I/F module 208, an input/output device 210 and a storage device 212 coupled for communication with each other via a bus 220. The modeling server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the modeling server 102 may include various operating systems, sensors, additional processors, and other physical configurations.

The processor 202 comprises an arithmetic logic unit, a microprocessor, a general purpose controller, a field programmable gate array (FPGA), a application specific integrated circuit (ASIC), some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. In some implementations, the processor(s) 202 may be coupled to the memory 204 via the bus 220 to access data and instructions therefrom and store data therein. The bus 220 may couple the processor 202 to the other components of the modeling server 102 including, for example, the display module 206, the network I/F module 208, the input/output device(s) 210, and the storage device 212.

The memory 204 may store and provide access to data to the other components of the modeling server 102. In some implementations, the memory 204 may store instructions and/or data that may be executed by the processor 202. For example, as depicted in FIG. 2, the memory 204 may store the geospatial model system 120 (as shown in FIG. 1), the model creator 104, and their respective components, depending on the configuration. The memory 204 is also capable of storing other instructions and data, including, for example, an operating system, hardware drivers, other software applications, databases, etc.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In one implementation, the memory 204 also includes a non-volatile memory such as a hard disk drive or flash drive for storing information on a more permanent basis. The memory 204 is coupled by the bus 220 for communication with the other components of the modeling server 102. It should be understood that the memory 204 may be a single device or may include multiple types of devices and configurations.

The display module 206 may include software and routines for sending processed data, analytics, or recommendations for display to a client device 114, for example, to allow an administrator to interact with the modeling server 102. In some implementations, the display module may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. The network I/F module 208 also provides other conventional connections to the network 106 for distribution of files using standard network protocols such as TCP/IP, HTTP, HTTPS and SMTP as will be understood to those skilled in the art. In an alternate implementation, the network I/F module 208 is coupled to the network 106 by a wireless connection and the network I/F module 208 includes a transceiver for sending and receiving data. In such an alternate implementation, the network I/F module 208 includes a Wi-Fi transceiver for wireless communication with an access point. In another alternate implementation, network I/F module 208 includes a Bluetooth® transceiver for wireless communication with other devices. In yet another implementation, the network I/F module 208 includes a cellular communications transceiver for sending and receiving data over a cellular communications network such as via short messaging service (SMS), multimedia messaging service (MMS), hypertext transfer protocol (HTTP), direct data connection, WAP, email, etc. In still another implementation, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the modeling server 102 and can be coupled to the system either directly or through intervening I/O controllers. The I/O devices 210 may include a keyboard, mouse, camera, stylus, touch screen, display device to display electronic images, printer, speakers, etc. An input device may be any device or mechanism of providing or modifying instructions to the modeling server 102. An output device may be any device or mechanism of outputting information from the modeling server 102, for example, it may indicate status of the modeling server 102 such as: whether it has power and is operational, has network connectivity, or is processing transactions.

The storage device 212 is an information source for storing and providing access to data, such as geospatial data. The data stored by the storage device 212 may be organized and queried using various criteria including any type of data stored by it. The storage device 212 may include data tables, databases, or other organized collections of data. The storage device 212 may be included in the modeling server 102 or in another computing system and/or storage system distinct from but coupled to or accessible by the modeling server 102. The storage device 212 can include one or more non-transitory computer-readable mediums for storing data. In some implementations, the storage device 212 may be incorporated with the memory 204 or may be distinct therefrom. In some implementations, the storage device 212 may store data associated with a database management system (DBMS) operable on the modeling server 102. For example, the DBMS could include a structured query language (SQL) DBMS, a NoSQL DBMS, various combinations thereof, etc. In some instances, the DBMS may store data in multi-dimensional tables comprised of rows and columns, and manipulate, e.g., insert, query, update and/or delete, rows of data using programmatic operations.

The bus 220 represents a shared bus for communicating information and data throughout the modeling server 102. The bus 220 can include a communication bus for transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the server 102 (operating systems, device drivers, etc.), and any of the components of the model creator 104 may cooperate and communicate via a communication mechanism included in or implemented in association with the bus 220. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The geospatial model system 120 includes a computer program that takes as input the model created by 104. Depending on the implementation, the geospatial model system 120 may provide different features and functionality. Examples of features and functionality include anomalous location detection, location (predicted using the model) based recommendations, location (predicted using the model) based search results, or any other use of location.

In one implementation, the geospatial model system 120 uses the model created by 104 and a user's current location to determine whether the user's current location (or their device's current location) is an anomaly. In one implementation, such detection of anomalies may be useful for identifying threats or security risks. For example, the user's current location is near a VIP and it is an anomalous location for the user, or the user's current location is in a restricted area (geo-fence) and it is an anomalous location for the user.

In one implementation, the geospatial model system 120 uses the model created by 104 for location based recommendations. For example, the geospatial model system 120 uses the model to predict that you are at a particular location during lunch on Wednesdays and provides a recommendation and/or advertisement for a nearby restaurant.

In one implementation, the geospatial model system 120 uses the model created by 104 for location based searching. For example, the geospatial model system 120 uses the model to predict that you are at a particular location when you search “mechanic” and the search results provide and prioritize mechanics near that predicted location.

In one implementation, the geospatial model system 120 uses the model created by 104 to determine whether the uncertainty in the model is above a threshold and pings the device 114 (or user 116 thereof) to obtain the device's 114 location.

In one implementation, the geospatial model system 120 uses the model created by 104 by converting probability densities of the model into probability scores.

As depicted in FIG. 2, the model creator 104 may include and may signal the following to perform their functions: a data collection module 222 that receives data from one or more of the network I/F module 208, a storage device 212 and input/output device 210 and passes it on to the data preparation module 224, a data preparation module 224 that receives the data from the data collection module 222, and prepares the data for use by the weighting module 226 and model generator module 228 and then passes it on to the weighting module 226 and model generator module 228, a weighting module 226 that determines one or more weighting (e.g. decay coefficients and an algorithm for combining multiple weightings), a model creator module 228 for generating a model using the weightings and geospatial data and an update module 230 for updating the model. These components 222, 224, 226, 228, 230, and/or components thereof, may be communicatively coupled by the bus 220 and/or the processor 202 to one another and/or the other components 206, 208, 210, and 212 of the modeling server 102. In some implementations, the components 222, 224, 226, 228, 230 may include computer logic (e.g., software logic, hardware logic, etc.) executable by the processor 202 to provide their actions and/or functionality. In any of the foregoing implementations, these components 222, 224, 226, 228, 230 may be adapted for cooperation and communication with the processor 202 and the other components of the modeling server 102.

The data collection module 222 includes computer logic executable by the processor 202 to collect geospatial data from one or more information sources, such as computing devices and/or non-transitory storage media (e.g., databases, servers, etc.) configured to receive and satisfy data requests. In some implementations, the data collection module 222 obtains information from one or more of a third party server 122, the data collector 108, the client device 114, and other providers. For example, the data collection module 222 obtains geospatial data by sending a request to one or more of the server 108, 122 via the network I/F module 208 and network 106.

The data collection module 222 is coupled to the storage device 212 to store, retrieve, and/or manipulate data stored therein and may be coupled to the data preparation module 224, the weighting module 226, the model generator 228, the update module 230, and/or other components of the model creator 104 to exchange information therewith. For example, the data collection module 222 may store, retrieve, and/or manipulate geospatial data aggregated by it in the storage device 212, and/or may provide the data aggregated and/or processed by it to one or more of the data preparation module 224, the weighting module 226 and the model generator 228 (e.g., preemptively or responsive to a procedure call, etc.).

The data collection module 222 collects data and performs operations described throughout this specification. It should be understood that other configurations are possible and that the data collection module 222 may perform operations of the other components of the system 100 or that other components of the system may perform operations described as being performed by the data collection module 222.

The data preparation module 224 includes computer logic executable by the processor 202 to augment and organize the geospatial data as collected by the data collection module 222. In some implementations, the data preparation module 224 is coupled to the storage device 212 to organize and combine geospatial data into rows and otherwise organize and augment the data collected by the data collection module 222.

Geospatial data identifies who was where at what time. In one implementation, a set of geospatial data includes an identifier component (i.e. the “who”), a time component (i.e. the “when”) and a location component (i.e. the “where”). However, in some implementations additional information may be included in the geospatial data including, but not limited to a group membership of the identified “who”, one or more demographics of the identified “who”, weather at the time and location of the geospatial data point, lunar phase at the time and location of the geospatial data point, tidal information at the time and location of the geospatial data point (e.g. high tide, low tide, spring tide, neap tide), event(s) at the time and location of the geospatial data point, etc.

In one implementation, an identifier component identifies a user 116 or a client device 114 of a user 116. Examples of identifier components include, but are not limited to, one or more of a user's given name, a username, an IP address, an e-mail, a phone number, address, electronic serial number (ESN), media access control (MAC) address, etc. In one implementation, a location component identifies a location of the user device 114 and/or the user 116 thereof. Example of location components include, but are not limited to, one or more of global positioning satellite (GPS) coordinates, cell tower ID, Wi-Fi network, street address, etc. In one implementation, a time component identifies a time, e.g., a time stamp. It should be recognized that the preceding are merely examples and that other examples of components are within the scope of this disclosure.

In some implementations, the geospatial data may not be homogenous. For example, some sets of geospatial data may use GPS coordinates while other geospatial data may use a cellular tower identifier of the nearest cellular tower. In one implementation, the data preparation module 224 may augment the geospatial data by converting location components into a common location component (e.g. converting to GPS coordinates). This augmentation of the geospatial data to create a common location component among data from different sets of geospatial data that use heterogeneous location components may be referred to herein as normalizing the location component.

In some implementations, the data preparation module 224 may augment the geospatial data by identifying common users or devices and grouping the data. For example, assume that the email address userA@gmail.com is associated with User A and an identifier component in a first set of geospatial data and the electronic serial number 12345 is also associated with User A (e.g. 12345 is the ESN of the user's cellular phone) and is an identifier component in a second set of geospatial data; in one implementation, the data preparation module 224 may identify the common user and augment the geospatial data so that userA@gmail.com is the common identifier component for the second set of geospatial data. This augmentation of the geospatial data to create a common identifier component among data from different sets of geospatial data that use heterogeneous identifier components may be referred to herein as normalizing an identifier component.

In some implementations, the data preparation module 224 may augment the geospatial data to create a common time component (e.g. a uniform timestamp format) for data from different sets of geospatial data that use heterogeneous time components (e.g. different time stamp formats), this may be referred to herein as normalizing a time component.

The weighting module 226 may include computer logic executable by the processor 202 to generate one or more weights based on one or more criteria. In some implementations, the weighting module 226 stores the weight in the storage device 212 for access by other components of the modeling server 102.

In one implementation, the one or more criteria include one or more of a time characteristic and a user characteristic. However, it should be recognized that additional or other characteristics may be included depending on the data available and/or desired use. For example, weather may be included in the weighting (this could account for a user not attending Saturday football game if the weather is poor), user device characteristics may be included (e.g. cellphone or smart watch data may be weighted differently from that of a tablet, laptop or desktop, which may not be as likely to be carried on a person and may, therefore, be less indicative of the associated user's current location), etc.

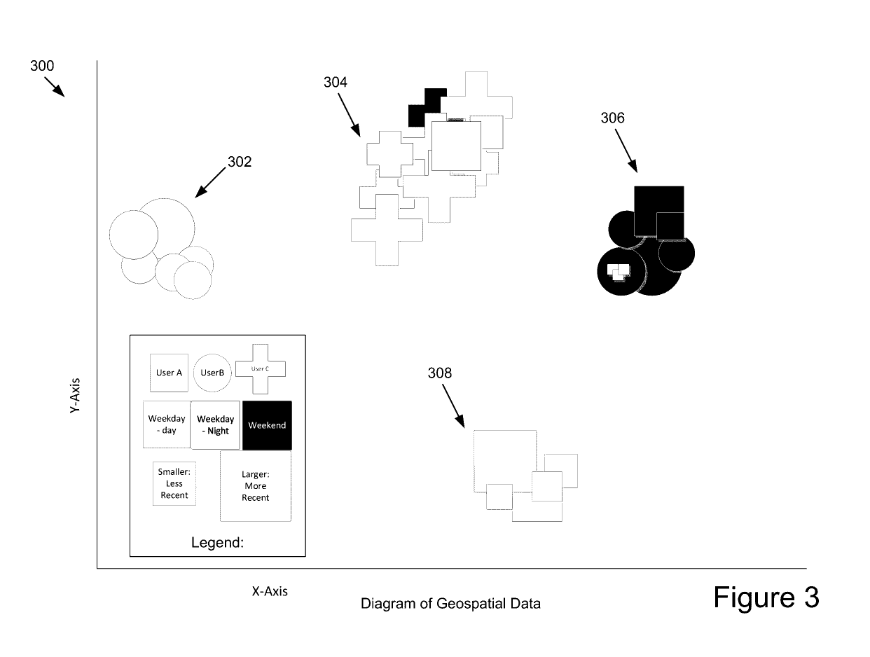

For clarity and convenience, some of the functionality and features of the weighting module 226 and model generator 228 are discussed herein with reference to the following example. Assume the one or more criteria include time characteristics of recentness and part of week and the user characteristic of similarity to User A because the geospatial location model for User A is being generated. Further assume the parts of the week are “weekday-day,” “weekday-night” and “weekend.” Referring now to FIG. 3, an example diagram 300 of geospatial data is illustrated according to an example implementation. In the example diagram, the X and Y axis are latitude and longitude and the location of a shape in the diagram is based on the location component of the set of geospatial data for that shape. In the example diagram, each shape is associated with a different user. Assume User A's past, known locations are visually represented by the squares, User B's past, known locations are visually represented by the circles and User C's past, known locations are visually represented by the crosses. In the example diagram, each shape size is associated with recentness. Assume the larger the shape the more recent. In the example diagram, each shade of the shape fill is associated with a different time of week. Assume white fill is associated with weekday-day, gray fill is associated with weekday-night and black fill is associated with the weekend.

Still referring to the FIG. 3, assume that the geospatial data when graphically represented produces the diagram 300 illustrated. From the diagram 300, many things can be inferred. For example, with regard to weekday-days, User A has been located at the location indicated as 306 but more recently has been located at the location indicated as 308, User B is known to be located at the location indicated as 302, and User C is known to be located at the location indicated as 304. With regard to weekday-nights, User A and User C are known to be located at the location indicated as 304, and User B is known to be located at the location indicated as 302. With regard to weekends, User A and User B are known to be located at the location indicated as 306, and User C is known to be located at the location indicated as 304.

As mentioned above, the weighting module 226 generates one or more weights based on one or more criteria, which in the present example include the time characteristics of recentness and time of week and a user characteristic of similar to User A (because a model of User A's geospatial location is to be generated).

If the model to be generated is for the weekday-day, in one implementation, the weighting module 226 determines that User B and C are not very similar to User A (as indicated by their white-filled shapes not being near to or commonly located with User A's white-filled shapes) and decreases the weighting associated with the geospatial data points associated with the other users. The weighting model 226 applies a time decay which decreases the weighting associated with User A's geospatial data at the location indicated as 306 because that data is relatively old. The weighting module 226 also decreases the weighting associated with the geospatial data points at the locations indicated as 304 and 306 because those geospatial data points are associated with a different part of the week.

If the model to be generated is for the weekday-night, in one implementation, the weighting module 226 determines that User B is not similar to User A but User C is similar (as indicated by crosses being near to or commonly located with User A's grey-filled squares) and decreases the weighting associated with the geospatial data points associated with User B and maintains or increases a weighting associated with User C. The weighting model 226 applies a time decay which decreases the weighting associated with User A's older geospatial data. The weighting module 226 also decreases the weighting associated with the geospatial data points at the locations indicated as 306 and 308 because those geospatial data points are associated with a different part of the week.

If the model to be generated is for the weekend, in one implementation, the weighting module 226 determines that User C is not very similar to User A but user B is similar (as indicated by the black-filled circles being near to or commonly located with User A's black-filled squares) and decreases the weighting associated with the geospatial data points associated with User C and maintains or increases a weighting associated with User B. The weighting model 226 applies a time decay which decreases the weighting associated with User A's older geospatial data. The weighting module 226 also decreases the weighting associated with the geospatial data points at the locations indicated as 304 and 308 because those geospatial data points are associated with a different part of the week.

Referring again to FIG. 2, in one implementation, one or more heuristics are used to determine whether user characteristics are similar and/or similarity within a time characteristic (e.g. how similar weekday-day data is to weekend date) are to be used in generating the weightings.

In one implementation, the weighting module 226 ultimately associates a single weight with each geospatial data point. In one implementation, the weighting module 226 associates a single weight with each dimension (e.g. one with the latitude/x-axis and one with the longitude/y-axis) of the geospatial data point. In one implementation, the weighting module 226 first assigns an intermediate weight based on each of the one or more criteria (e.g. a recentness weight, a time of week weight, and a similarity to User A weight) and then combines (e.g. as a product or using a more complicated algorithm) the intermediary weights to generate a single weight for that data point. In one implementation, the weightings are based on machine learning (e.g. to determine a decay constant and/or determine the algorithm combining the weightings for multiple criteria). For example, machine learning is performed to generate a set of algorithms describing how the multiple criteria interact with one another and the effect of each on the weighting in order to obtain the most accurate model.

The model generator 228 may include computer logic executable by the processor 202 to generate one or more models based on the data collected by the data collection module 222. In some implementations, the model generator 228 stores the one or more models in the storage device 212 for access by other components of the modeling server 102.

The model generator 228 may use any number of various machine learning techniques to generate the model depending on the implementation. In one implementation, the model generator 228 uses the geospatial location data (including that of surrogates) and the Kernel Density Functions of Equation 1 and Equation 2, below, to generate the geospatial model for the user of interest, which is User A in the above example.

$$p ( ( x , y ) \vert t ) = \frac{1}{{\sum }_{i = 1}^{N} {w}_{i} ( {x}_{i} , {y}_{i} )} {\sum }_{i = 1}^{N} {w}_{i} ( {x}_{i} , {y}_{i} ) K ( ( x - {x}_{i} , y - {y}_{i} ) ; σ ) \qquad ( Equation 1 )$$

Where xᵢ is the x-coordinate of the geospatial data point i.

Where yᵢ is the y-coordinate of the geospatial data point i.

Where K((x−xᵢ, y−yᵢ);σ) is the kernel density function, e.g.,

$$K ( x , y ; σ ) = \frac{1}{2 {πσ}^{2}} {e}^{- \frac{{x}^{2} + {y}^{2}}{2 {σ}^{2}}}$$

(a bivariate Gaussian kernel).

Where σ is a bandwidth parameter.

Where wᵢ(xᵢ, yᵢ)≧0 is the weight determined by the weighting module 226 for geospatial data point i.

Where

$$\frac{1}{{\sum }_{i = 1}^{N} {w}_{i} ( {x}_{i} , {y}_{i} )}$$

is a normalization factor ensuring density p integrates to 1.

When the only criterion being weighted is recentness, it should be recognized that wᵢ(xᵢ, yᵢ) is a time decay. For example, wᵢ(xᵢ, yᵢ) is a time decay having the form of Equation 2, below.

wᵢ(xᵢ)=e^{-λ(t-t}^{ᵢ}⁾ (Equation 2)

Where λ is the non-negative time decay parameter and t−tᵢ is the elapsed time from the time the model is being generated (t) to the time component (e.g. time stamp) of geospatial data point i (tᵢ). It should also be recognized that such a time decay may impose a threshold at which point the geospatial data point is disregarded. It should further be recognized that the weighting may differ in complexity and terms based on the one or more criteria. For example, in an implementation where the weighting module 226 uses a simple product of intermediate weightings, wᵢ(xᵢ, yᵢ) may have a form similar to Equation 3, below.

wᵢ(xᵢ,yᵢ)=e^{-λ(t-t}^{ᵢ}⁾e^{-u(h,h}^{ᵢ}⁾e^{-d(ƒ,ƒ}^{ᵢ}⁾ (Equation 3)

where e^{-λ(t-t}^{ᵢ}⁾ is the intermediate weighting for recentness as discussed above with Reference to Equations 2.

where e^{-u(h,h}^{ᵢ}⁾ is the intermediate weighting for user similarity in which a non-negative function u(h, hᵢ) is 0 if h=hᵢ, and with values of u closer to zero the more predictive geospatial data point i is with regard to user similarity, h representing some user attribute.

where e^{-d(ƒ,ƒ}^{ᵢ}⁾ is the intermediate weighting for part of week in which a non-negative function d(ƒ, ƒᵢ) is 0 if ƒ=ƒᵢ, and with values of d closer to zero the more predictive geospatial data point i is with regard to the part of week, ƒ representing some attribute of the part of the week.

It should be recognized that the functional form of Equation 2 (i.e. exponential drop-off) and the product format of Equation 3 is merely one implementation and other functions may be used to combine the intermediate weightings and/or determine the various decay parameter λ and functions u and d that result in the most accurate model.

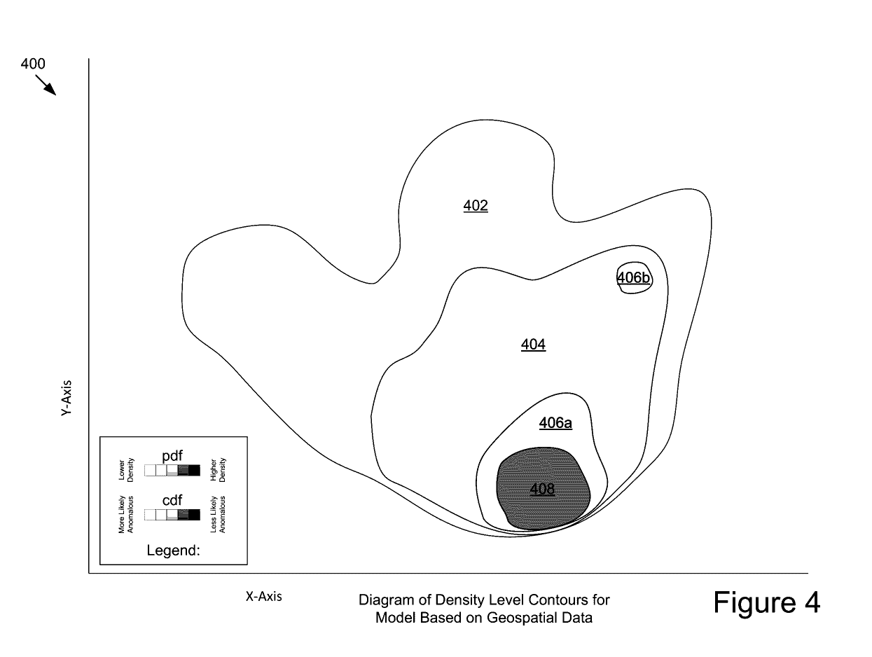

Referring now to FIG. 4, a diagram of a graphic representation of a geospatial location model 400 is illustrated according to one implementation. In the illustrated implementation, the probability density function of the generated geospatial model is displayed as a topographical probability map; however, it should be recognized that the model may be represented in other ways including, for example, as a 3-dimensional contour, a heat map, converting the probability densities to probability scores, etc.

Assume the geospatial model 400 illustrated is for predicting the location of User A on a weekday during the day (i.e. weekday-day) of the Example discussed above with reference to FIG. 3. It should be recognized that the diagram 400 of FIG. 400 is an illustration meant to clarify certain aspects of the disclosure and that the contours of 402, 404, 406a-b and 408 were drawn freehand using principles of the disclosed method (not calculated using the disclosed method). Therefore, the contours are primarily intended to provide a qualitative idea of how graphical representation of a model generated from the geospatial data of FIG. 3 using weightings and the surrogate data (i.e. data for users other than User A and data for other periods of the week), as described above, may appear.

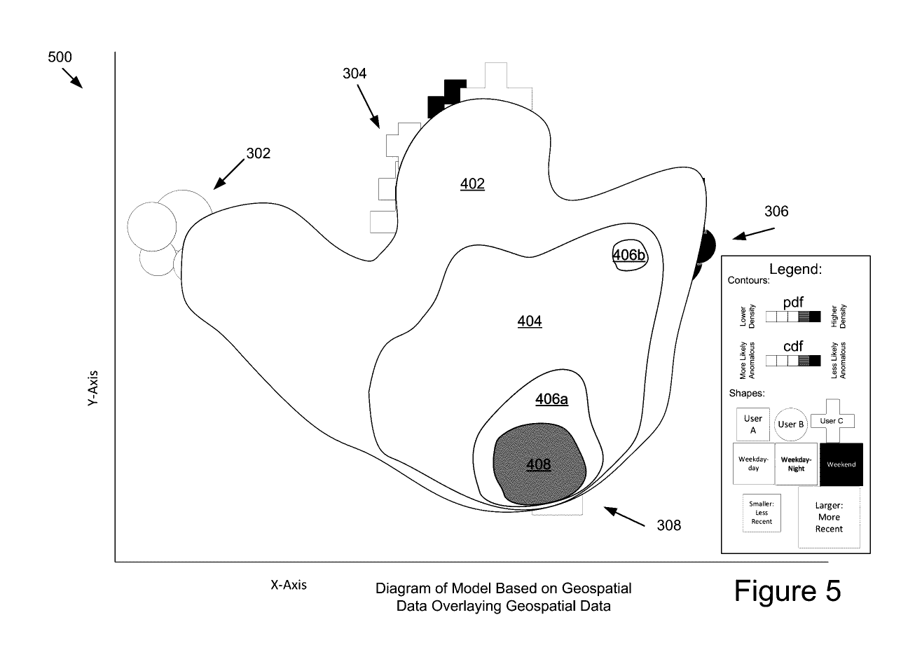

In the diagram 400, a tall probability peak is expected at the location indicated by 308 in FIG. 3, and FIG. 4 has a high peak at 408. Also in diagram 400, a second peak is expected to be at the location indicated by 306 in FIG. 3, and in FIG. 4, a second peak is located at 406b. The peak at 406b is lower than that of 408, which is logical because User A was located there less recently and less frequently. FIG. 5 shows the graphical representation of the model of FIG. 4 overlaid on the geospatial data for FIG. 5 to further illustrate the correspondence between the peaks in the model and the geospatial data.

Referring again to FIG. 4, in one implementation, the contours 402, 404, 406a-b, 408 may have statistical significance. In 400, the lighter the shade of the topographical shapes; the more likely it is that the user is located within the boundaries of that shape. For example, there may be a 99% chance User A is located within the bounds of 402, a 95% chance User A is located within the bounds of 404, a 75% chance User A is located within the bounds of 406 which is bi-modal as illustrated by having shapes 406a and 406b), and a 50% chance User A is located with the bounds of 408.

In one implementation, each of the contours in FIGS. 4 and 5 is a level curve for a particular probability density function (pdf) pₜ(x, y)=p((X=x, Y=y)|t) from Equation 1, where (X,Y) is the random variable pair for the geo location. Let Cₜ denote the cumulative distribution function (cdf) for the values of the pdf pₜ:

Cₜ(x,y)= [symbol] ({pₜ(x′,y′)≦pₜ(x,y):(x′,y′)˜pₜ}). (Equation 4)

Each of the level curves for the pdf pₜ is also the level curve for the cdf Cₜ. We propose to use the cdf value Cₜ(x, y)= [symbol] ({pₜ(x′, y′)≦pₜ(x, y):(x′,y′)˜pₜ}) from the Equation 4 as the anomaly index for a location (x,y) as it indicates how unlikely is the User to be seen at (x,y) as compared to other locations. For example, if c=0.01, then all points (x,y) such that Cₜ(x, y)<c would have the smallest 1% of the probability density function values, i.e., the 1% of least likely points according to the distribution, and would be considered anomalous.

Note that we do not have a straightforward way of computing the values of cdf Cₜ. However, the cdf Cₜ(x,y) is monotonically increasing in pₜ(x,y), and there is a one-to-one correspondence between the values of Cₜ and pₜ for their level curves. If c=Cₜ(x,y), then the corresponding value p_{c}=pₜ(x, y) satisfies

[symbol]

({pₜ(x′,y′)≦p_{c}:(x′,y′)˜pₜ})=c, (Equation 5)

In fact, the value p_{c} of pₜ corresponding to c=Cₜ(x,y) for an unknown (x,y) can be viewed as the quantile value for Cₜ as

p_{c}=in ƒ{pεR:c≦ [symbol] ({pₜ(x′,y′)≦p:(x′,y′)˜pₜ})}.

While for the general case, p_{c} cannot be obtained from c analytically, if (X,Y) are jointly normal with covariance Σ, then

$${p}_{c} = \frac{c}{2 π \sqrt{\vert E \vert}} .$$

In one implementation, the above estimate of p_{c} is used as a heuristic for the cases where (X,Y) are not jointly normal. In one of the implementations with the above heuristic, for the case of Kernel Density Estimator (KDE) in the Equation 1, the covariance |Σ|=Cov(X, Y|t) can be easily estimated using the Law of Total Covariance to obtain a heuristic approximation of normal:

Cov(X,Y|t)=σ²I₂+Cov_{W}(X,Y) (Equation 6)

where Cov_{W}(X, Y) is a sample covariance obtained from points (xᵢ, yᵢ) with the corresponding weights wᵢ(xᵢ, yᵢ), i=1, . . . N.

Alternatively, one can estimate Cₜ(x,y) from the distribution pₜ. In one implementation, q is estimated as:

$${\hat{C}}_{t} ( x , y ) \approx \frac{1}{N} {\sum }_{j = 1}^{N} I ( {p}_{t} ( {x}_{j} , {y}_{j} ) \leq {p}_{t} ( x , y ) )$$

Where I(•) is an indicator function;

Where (x₁, y₁), . . . , (x_{N}, y_{N}) are independent and identically distributed samples from the location distribution with the probability density function pₜ.

The update module 230 includes computer logic executable by the processor 202 to take new data and update the models created by the weighting module 226 based on the new data. In some implementations, the update module 230 may access the model(s) and/or data stored in the storage device 212 to determine whether a model needs to be updated. For example, the update module 230 may determine that new data, such as new user location data, has been received and a model should be recalculated based on the new data.

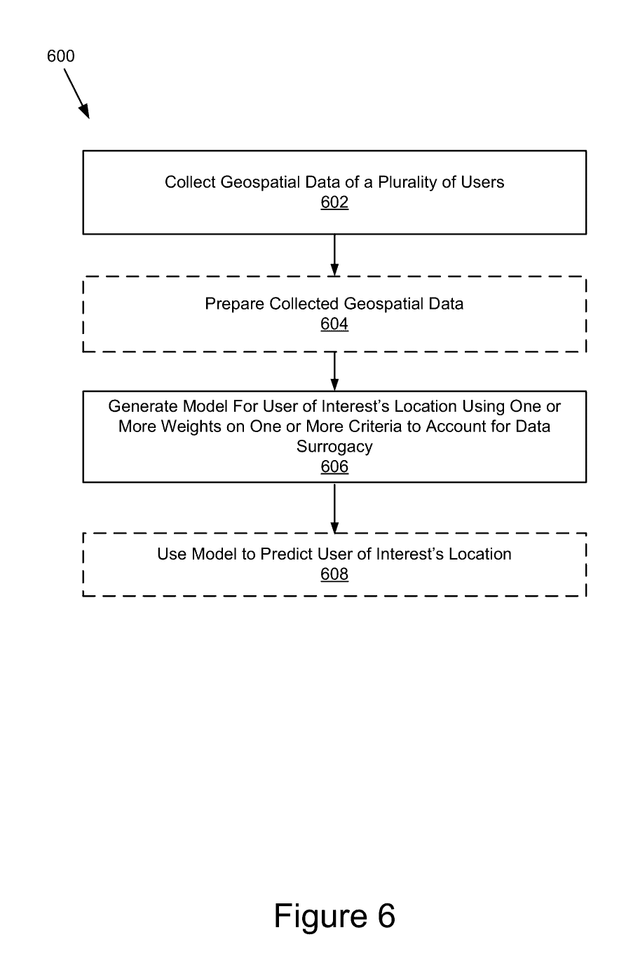

FIG. 6 is a flowchart of an example method 600 according to one implementation. The method 600 begins at block 602. At block 602, the data collection module 222 collects geospatial data of a plurality of users including the user of interest and at least one other user. At block 604, the data preparation module 224 prepares the collected geospatial data. At block 606, the model generator 228 generates a model of the user of interest's location using one or more weights for one or more criteria to account for data surrogacy. At block 608, the model generated at block 606 is used (e.g. by the geospatial model system 120) to predict a user's location. The predicted location may be used by the geospatial model system as described above to provide location based features or functionality.

It should be understood that while FIG. 6 includes a number of steps in a predefined order, the methods may not necessarily perform all of the steps or perform the steps in the same order. The method may be performed with any combination of the steps (including fewer or additional steps) different than that shown in FIG. 6, and the method may perform such combinations of steps in other orders.

In the above description, for purposes of explanation, numerous specific details are set forth in order to provide a thorough understanding of the present disclosure. It will be apparent, however, to one skilled in the art that the technology described herein can be practiced without these specific details. In other instances, structures and devices are shown in block diagram form in order to avoid obscuring the description. For example, the implementations are described in one implementation above with reference to particular hardware and software implementations. However, the present disclosure applies to other types of implementations distributed in the cloud, over multiple machines, using multiple processors or cores, using virtual machines or integrated as a single machine.

Reference in the specification to “one implementation” or “an implementation” means that a particular feature, structure, or characteristic described in connection with the implementation is included in at least one implementation. The appearances of the phrase “in one implementation” in various places in the specification are not necessarily all referring to the same implementation. In particular, the disclosure above discusses multiple distinct architectures and some of the components are operable in multiple architectures while others are not.

Some portions of the above detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is described without reference to any particular programming language. It will be appreciated that a variety of programming languages may be used to implement disclosure herein.

The foregoing description has been presented for the purposes of illustration and description. It is not intended to be exhaustive or to limit the specification to the precise form disclosed. Many modifications and variations are possible in light of the above teaching. It is intended that the scope be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the present disclosure, which is set forth in the following claims.

1. A method comprising:
collecting, using one or more processors, geospatial data of a plurality of users, the plurality of users including a user of interest and other users; and
generating, using the one or more processors, a model for the user of interest's location based on the collected geospatial data using one or more weights associated with one or more criteria to account for data surrogacy.

2. The method of claim 1, the method further comprising:
receiving information associated with an observed location, (x,y), wherein the information includes one of a probability density score associated with the observed location and the log of the probability density score associated with the observed location;
receiving a quantile threshold, c;
determining a density value, p_{c}, corresponding to the received quantile threshold;
determining that the observed location is an outlier when p((X=x, Y=y)|t)<p_{c}; and
initiating an action based on determining the observed location is an outlier.

3. The method of claim 1, wherein the one or more criteria includes a time characteristic and the data surrogacy includes time surrogacy.

4. The method of claim 3, wherein the weights one or more of emphasize geospatial data associated with a first time characteristic in generating the model and de-emphasize the geospatial data associated with a second time characteristic in generating the model, the model used to predict the user of interest's location at a time consistent with the first time characteristic.

5. The method of claim 1, wherein the one or more criteria includes a user characteristic and the data surrogacy includes user surrogacy.

6. The method of claim 5, wherein the weights one or more of emphasize geospatial data associated with one or more other users similar to the user of interest in generating the model and de-emphasize the geospatial data associated with one or more other users dissimilar to the user of interest in generating the model.

7. The method of claim 1, wherein the one or more criteria includes a user characteristic and a time characteristic and the data surrogacy includes user surrogacy and time surrogacy.

8. The method of claim 1, the method further comprising:
predicting, using the model for the user of interest's location, a current location of the user of interest; and
initiating an action based on the predicted, current location of the user.

9. The method of claim 8, wherein the action includes one or more of requesting, generating and providing a location based recommendation.

10. The method of claim 8, wherein the action includes one or more of requesting, generating and providing a location based search result.

11. A system comprising:
one or more processors; and
a memory storing instructions that, when executed by the one or more processors, cause the system to:
collect geospatial data of a plurality of users, the plurality of users including a user of interest and other users; and
generate a model for the user of interest's location based on the collected geospatial data using one or more weights associated with one or more criteria to account for data surrogacy.

12. The system of claim 11, the instructions, when executed, further causing the system to:
receive information associated with an observed location, (x,y), wherein the information includes one of a probability density score associated with the observed location and the log of the probability density score associated with the observed location;
receive a quantile threshold, c;
determine a density value, p_{c}, corresponding to the received quantile threshold;
determine that the observed location is an outlier when p((X=x, Y=y)|t)<p_{c}; and
initiate an action based on determining the observed location is an outlier.

13. The system of claim 11, wherein the one or more criteria includes a time characteristic and the data surrogacy includes time surrogacy.

14. The system of claim 13, wherein the weights one or more of emphasize geospatial data associated with a first time characteristic in generating the model and de-emphasize the geospatial data associated with a second time characteristic in generating the model, the model used to predict the user of interest's location at a time consistent with the first time characteristic.

15. The system of claim 11, wherein the one or more criteria includes a user characteristic and the data surrogacy includes user surrogacy.

16. The system of claim 15, wherein the weights one or more of emphasize geospatial data associated with one or more other users similar to the user of interest in generating the model and de-emphasize the geospatial data associated with one or more other users dissimilar to the user of interest in generating the model.

17. The system of claim 11, wherein the one or more criteria includes a user characteristic and a time characteristic and the data surrogacy includes user surrogacy and time surrogacy.

18. The system of claim 11, the instructions, when executed, further causing the system to:
predict, using the model for the user of interest's location, a current location of the user of interest; and
initiate an action based on the predicted, current location of the user.

19. The system of claim 18, wherein the action includes one or more of requesting, generating and providing a location based recommendation.

20. The system of claim 18, wherein the action includes one or more of requesting, generating and providing a location based search result.
